(19) United States
(12) Patent Application Publication
(10) Pub. No.: US 2020/0130225 A1
(43) Pub. Date: Apr. 30, 2020

(54) DEVICES, SYSTEMS AND METHODS RELATING TO EXCAVATOR/THUMB WOOD SPLITTER

(71) Applicant: SideTool, Inc., Eatonville, WA (US)

(72) Inventor: Stephen T. Schmidt, Eatonville, WA (US)

(73) Assignee: SideTool, Inc., Eatonville, WA (US)

(21) Appl. No.: 16/664,352

(22) Filed: Oct. 25, 2019

Related U.S. Application Data
(60) Provisional application No. 62/751,568, filed on Oct. 27, 2018.

(51) Int. Cl. B27L 7/06; A01G 23/099

(52) U.S. Cl. CPC B27L 7/06; A01G 23/099

(57) ABSTRACT

Wood splitters configured and sized to be removably attach to an articulating arm on a mobile power machine such as backhoes, tractors, excavators or bulldozers. The articulating arm is attached to a powered wood splitter, which comprises a pusher comprising a wood holder area and an opposed splitter knife attached to the opposed thumb. The power of the mobile power machine is then activated to open the powered wood splitter to either capture/grab a piece of wood or to release it, or to close/squeeze, the pusher and splitter knife together, thereby splitting the wood held between them.

### CROSS-REFERENCE TO RELATED APPLICATIONS

The present application claims the benefit of copending U.S. Provisional Patent Application Ser. No. 62/751,268 entitled “EXCAVATOR/THUMB WOOD SPLITTER”, filed Oct. 27, 2018, which application is incorporated herein by reference in its entirety.

### BACKGROUND

Splitting logs and wood has traditionally been a time consuming activity that is labor-intensive and possibly dangerous. Powered wood splitters have been developed, typically comprising a bed to hold a log placed there by a person, a backstop to hold the log in place during splitting, and a ram forced into the log to thereby split the log. Such devices, however, are generally not highly mobile, still require significant human strength to lift the logs into place and remove them after splitting, and can still be unduly dangerous.

Thus, there has gone unmet a need for improved systems and methods, etc., that improve efficiency, economy and/or safety of wood splitting. The present systems and methods, etc., provide one or more of these and/or other advantages.

### SUMMARY

The present systems, and methods, etc., provide wood splitters disposed on a mobile power machine that has an articulating arm that holds a removable bucket opposed to a thumb. Such mobile power machines include, for example, backhoes, tractors, excavators, bulldozers, or any other mobile power machine comprising a powered arm that comprises a bucket or end-device comprising opposable elements that open and close. One typical arrangement is a digging bucket opposed to a thumb wherein at least one of the digging bucket and/or thumb can be reciprocated toward or away from the opposed element. The power to the articulating arm and/or bucket can be provided by any desired suitable approach such as hydraulics or pneumatics. Typically, the removable bucket is removed and replaced with a pusher comprising a wood holder area and a splitter knife attached to the opposed thumb, then the power of the mobile power machine is activated to squeeze (close) the pusher and knife together, thereby splitting the wood held between them.

In some aspects, the present systems, devices and methods, etc., provide mobile machines having at least one powered articulating arm, the powered articulating arm comprising a powered wood splitter disposed thereon wherein the powered wood splitter can comprise at least a pusher reciprocatingly opposed to a knife. The powered wood splitter can be operably connected to controls for the mobile machine that controllably reciprocate the pusher and the knife toward or away from each other, which machine can be a tractor, backhoe or excavator and the controls can be located in a cab of the mobile machine. For example, the controls can be the typical controls that control the opening and closing of the bucket that is typically attached to the powered articulating arm.

The knife and the pusher can be disposed on a distal end of the powered articulating arm, and the knife can be removably attached to a thumb opposed to the pusher. The pusher can be removably attached to a bucket connector on the powered articulating arm, which bucket connector is sized and configured to hold an excavating bucket to the powered articulating arm. The bucket connector can be an excavator coupler. The knife can comprise a plurality of blades disposed at about 90° to each other.

Also provided herein are wood splitting systems comprising the pusher and the knife, as well as each of the pusher or the knife separately as a stand-alone device. The pusher can comprise a wood holder area and a plurality of pusher connection elements sized and configured to removably attach the pusher to a first side of a distal end of a powered articulating arm of a mobile machine, the pusher connection elements having a configuration consistent with an excavator coupler. The knife can comprise an edged side and a second side, the second side having a plurality of knife connection elements comprising at least one of sliding brackets or spaced holes, such knife connection elements are sized and configured to removably attach the knife to a thumb located at a second side of the distal end of the powered articulating arm wherein the second side can be substantially opposed to the first side of the powered articulating arm. The knife connection elements can comprise both sliding brackets and spaced holes. The sliding brackets and spaced holes can be disposed such that the knife connection elements can be adjusted for both height and width to attach to thumbs of different sizes.

The edged side of the knife can comprise a plurality of blades disposed at about 90° to each other. The pusher connection elements can comprise a rotatable arm sized and configured to be rotated to attach to differently sized powered articulating arms. The pusher connection elements can comprise a rotatable arm sized and configured to be rotated to attach to differently sized coupler pin widths and diameters disposed on different powered articulating arms.

The aspects herein also include certain methods that can take advantage of the systems, devices, etc., herein. For example, one such method comprises splitting wood by:
picking up a piece of wood between a pusher and a knife that can be both disposed on a powered articulating arm of a mobile machine,
squeezing the piece of wood between the pusher and the knife to split the wood to create at least two pieces of split wood.

In such methods, the mobile machine can be a tractor, backhoe or excavator and the squeezing can be activated via controls located in a cab of the mobile machine. The pusher and the knife can be opposed to each other at a distal end of the powered articulating arm of the mobile machine, and the knife can comprise a plurality of blades and the squeezing creates more than two pieces of split wood in a single squeeze. The methods further can comprise lifting the split wood between the pusher and the knife and then placing the split wood in a pile of split wood pieces.

Also provided herein are methods comprising operating the mobile machine containing the wood splitting systems discussed herein to split wood, as well as methods comprising attaching the wood splitting systems herein to the mobile machines herein.

Also included herein are methods comprising making or using the devices, systems, etc., herein.

These and other aspects, features and embodiments are set forth within this application, including the following Detailed Description and attached drawings. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 depicts a side elevational view of an exemplary mobile machine having a powered articulating arm with a powered wood splitter comprising a pusher reciprocatingly opposed to a knife with the powered wood splitter open.

FIG. 2 depicts a side view of an exemplary mobile machine having a powered articulating arm with a powered wood splitter comprising a pusher reciprocatingly opposed to a knife with the powered wood splitter partially closed and holding a log.

FIG. 3 depicts a side elevational view of an exemplary pusher as discussed herein.

FIG. 4 depicts a side elevational view of an exemplary knife as discussed herein, wherein the knife comprises a single edge.

FIG. 5 depicts a side elevational view of an exemplary knife as discussed herein, wherein the knife comprises plurality of edges.

FIG. 6 depicts a reverse side elevational view of an exemplary knife as discussed herein, wherein the knife comprises plurality of edges.

### DETAILED DESCRIPTION

The present systems, devices, methods, etc., provide powered wood splitters. The wood splitters are configured and sized to be removably attached to an articulating arm on a mobile power machine such as backhoes, tractors, excavators, bulldozers, or any other mobile power machine comprising a powered arm that comprises a bucket or end-device comprising powered opposable elements that open and close. One typical arrangement that can be replaced by the current powered wood splitters is an excavator bucket opposed to a thumb, wherein at least one of the digging bucket and/or thumb can be reciprocated toward or away from the other element. The power to the articulating arm and/or bucket can be provided by any desired suitable approach such as hydraulics, electronics or pneumatics.

In some embodiments herein, the removable bucket is removed from the articulating arm and replaced with the powered wood splitter, which comprises a pusher comprising a wood holder area and an opposed splitter knife attached to the opposed thumb. The power of the mobile power machine is then activated to open the powered wood splitter to either capture/grab a piece of wood or to release it, or to close, or squeeze, the pusher and knife together, thereby splitting the wood held between them.

The powered wood splitter can be operably connected to controls for the mobile machine that controllably reciprocate the pusher and the knife toward or away from each other, which machine can be a tractor, backhoe or excavator and the controls can be located in a cab of the mobile machine. For example, the controls can be the typical controls that control the opening and closing of the bucket that is typically attached to the powered articulating arm.

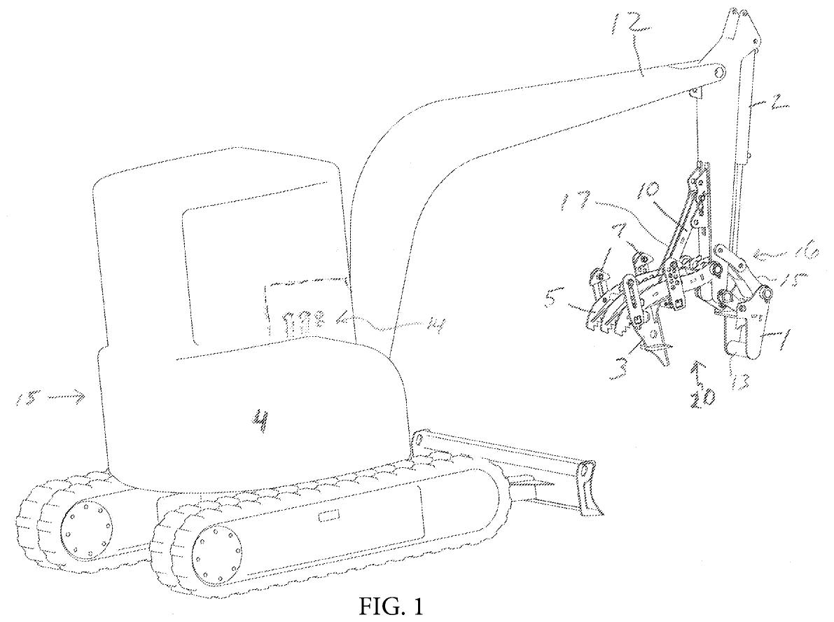

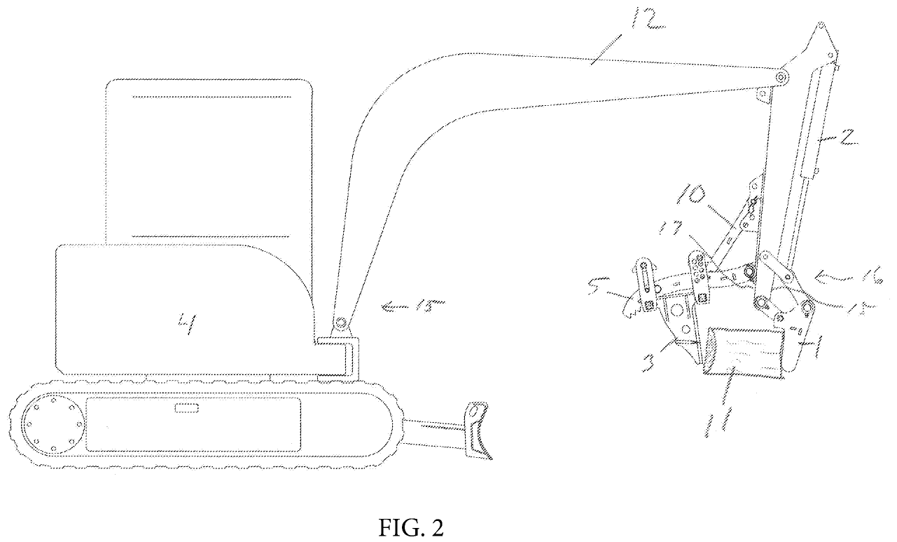

Thus, in some embodiments, the systems, etc., herein provide wood splitters utilizing a mobile machine with an articulating arm/thumb. Turning to a brief initial discussion of the figures, as shown in exemplary FIG. 1, the wood splitter 20 has a pusher 1 having a wood holder area that replaces/is disposed where a bucket would usually be placed on the articulating arm 12. The system utilizes the bucket hydraulic cylinder 2 to force the wood log (shown in FIG. 2) into the splitter knife 3.

The splitter knife 3 is placed on the underside of the thumb 5 of the articulating arm 12 of the mobile machine such as the excavator/backhoe 4 in FIGS. 1 and 2. The excavator/backhoe 4 may have either a ridged thumb 10 or a hydraulic operated thumb 5, such that either or both the thumb 6 or the pusher 1 can be move back and forth toward the other.

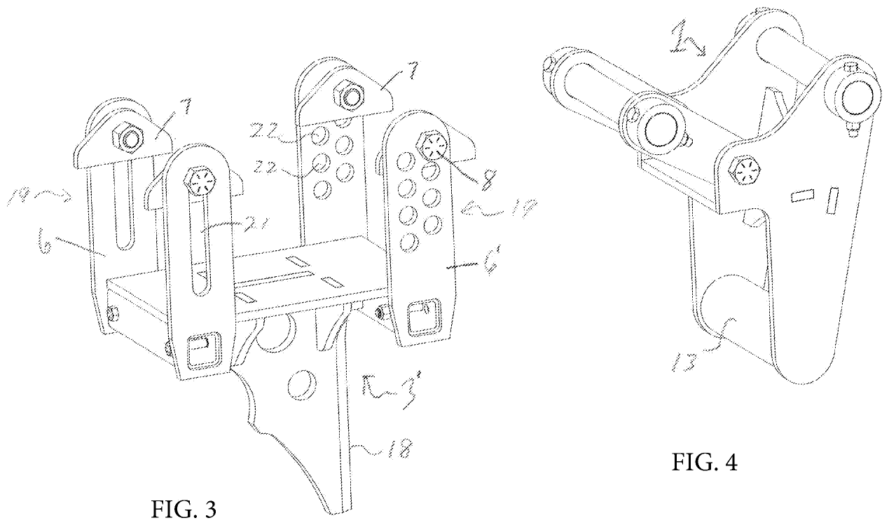

The splitter knife 3 can be held, as shown in FIGS. 1-6 (including single-blade splitter knife 3′ in FIG. 3), onto the thumb 5 by adjustable sliding brackets 6, which can be widened or narrowed to accommodate thumbs 5 of varying widths. The adjustable sliding brackets 6 of the splitter knife 3 are also adjustable to in height to account for varying thumb 5 thickness. Attachment eyes 7, which can be configured to provide a holding location for the articulating arm 12 to hold on to, are welded or otherwise attached on to the back of the thumb 5 and bolted 8 to the adjustable bracket 6.

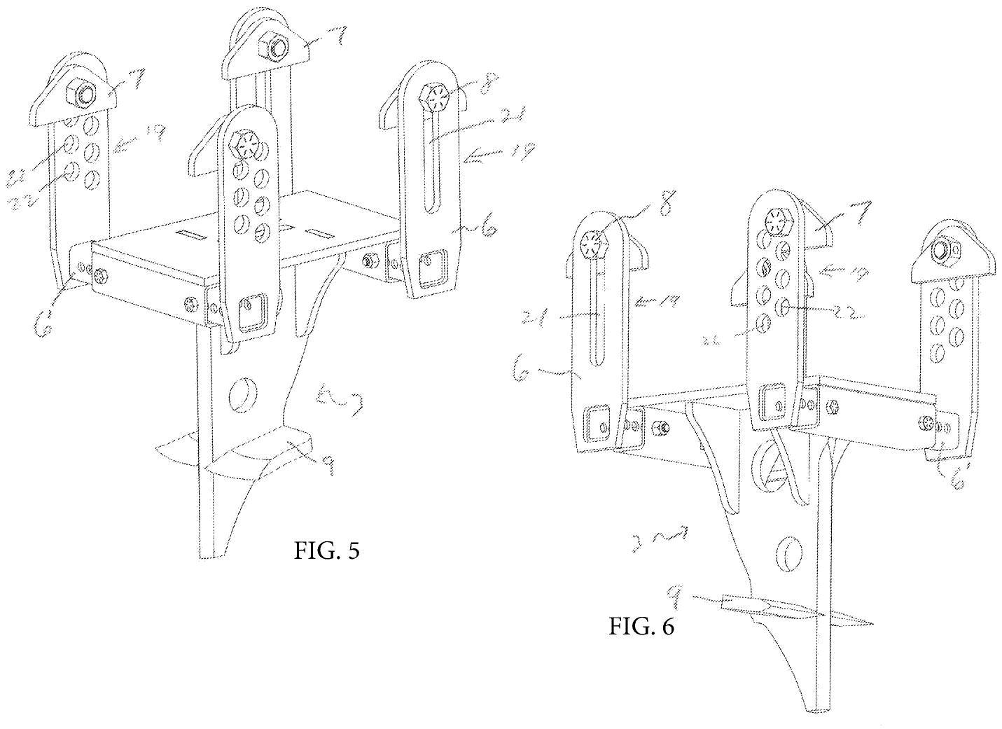

As shown more fully in FIGS. 5 and 6, the splitter knife 3 may also have additional cutting surfaces such as side blades 9 that allow for a 4-way split of the log round 11.

Referring more fully to FIGS. 1 and 2, a mobile powered machine 15 such as excavator/backhoe 4 has a powered articulating arm 12. The excavator/backhoe 4 also has a set of controls 14 such as handles or knobs, which controls are operably connected to the wood splitter 20 to open, close and otherwise manipulate it. The mobile powered machine 15 can be any mobile power machine comprising a powered arm that comprises a bucket (not shown) or other end-device comprising powered opposable elements that open and close, provided such opposable elements are large enough to grasp, squeeze and split a log. One suitable arrangement is a holder configured to hold a digging bucket that is opposed to a thumb. The power to the articulating arm and/or bucket can be provided by any desired power source such as electronics, hydraulics or pneumatics.

The removable bucket or other end device is removed and replaced with a pusher 1 comprising a wood holder area 13 and also a splitter knife 3 attached to the opposed thumb 5 of the articulating arm 12. The power of the mobile power machine 15 is activated to close/squeeze, the pusher 1 and splitter knife 3 together, thereby splitting the wood, such as log round 11 in FIG. 2, that is held between them. The splitter knife 3 is typically an elongate blade but any suitable wood-splitting configure can be used.

The wood splitter 20 is typically disposed at the distal end 16 the articulating arm 12 where a bucket, etc., would normally be. In FIGS. 1 and 2, the pusher 1 is disposed on a first side 15 of distal end 16 while the splitter knife 3 is disposed on a second side 17 of the distal end 16. Such second side 17 is typically substantially opposed to first side 15. The splitter knife 3 can comprise a single cutting point or blade for example as shown by splitter knife 3′ in FIG. 3, or a plurality of blades 9 which can be disposed at about 90° to each other.

FIG. 4 depicts a side elevational view of an exemplary splitter knife 3 as discussed herein, wherein the splitter knife 3 comprises a single cutting element, here a single cutting edge 18. FIGS. 5 and 6 depict a side elevational and reverse views of an exemplary splitter knife 3 as discussed herein, wherein the splitter knife 3 comprises plurality of edges 9. In all of FIGS. 4-6, the splitter knife 3 further comprises adjustable sliding brackets 6, 6′, which can be securely moved in and out to adapt to thumbs 5 of varying widths. Such adjustable sliding brackets 6, 6′ further comprise height-adjustment elements 19. In one exemplary embodiment, the height-adjustment elements 19 comprise elongate tracks 21 through which attachment eyes 7 can be moved up and down, while in another embodiment height-adjustment elements 19 comprise a series of spaced-apart holes 22 that can receive bolts 8 or other retention devices.

The present application is further directed to methods of making the various elements of the systems and apparatus herein, including making the systems and apparatus themselves from such elements, as well as to methods of using the same, including for example attaching or removing the wood splitter 20 to an articulating arm 20 or other suitable holding device. Such methods also include splitting wood, such as log round 11, or other suitable substrate using the wood splitters 20 herein.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

Unless otherwise stated, adjectives herein such as “substantially” and “about” that modify a condition or relationship characteristic of a feature or features of an embodiment, indicate that the condition or characteristic is defined to within tolerances that are acceptable for operation of the embodiment for an application for which it is intended.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

1. A mobile machine having a powered articulating arm, the powered articulating arm comprising a powered wood splitter disposed thereon wherein the powered wood splitter comprises at least a pusher reciprocatingly opposed to a splitter knife, wherein the powered wood splitter is operably connected to controls for the mobile machine that controllably reciprocate the pusher and the splitter knife toward or away from each other, wherein the splitter knife is removably attached to a thumb of the articulating arm that is opposed to the pusher.

2. The mobile machine of claim 1 wherein the mobile machine is a tractor, backhoe or excavator and the controls are located in a cab of the mobile machine.

3. The mobile machine of claim 1 wherein the splitter knife and the pusher are disposed on a distal end of the powered articulating arm.

4. The mobile machine of claim 1 wherein the pusher is removably attached to a bucket connector on the powered articulating arm sized and configured to hold an excavating bucket to the powered articulating arm.

5. The mobile machine of claim 4 wherein the bucket connector is an excavator coupler.

6. The mobile machine of claim 1 wherein the splitter knife comprises a plurality of blades disposed at about 90° to each other.

7. A wood splitting system comprising a pusher and a splitter knife, wherein the pusher comprises a wood holder area and a plurality of pusher connection elements that are sized and configured to removably attach the pusher to a first side of a distal end of a powered articulating arm of a mobile machine, the pusher connection elements having a configuration consistent with an excavator coupler, and wherein the splitter knife comprises an edged side and a plurality of splitter knife connection elements comprising at least one of sliding brackets or spaced holes, such splitter knife connection elements sized and configured to removably attach the splitter knife to a thumb located at a second side of the distal end of the powered articulating arm wherein the second side is substantially opposed to the first side of the powered articulating arm.

8. The wood splitting system of claim 7 wherein the splitter knife connection elements comprise both sliding brackets and spaced holes.

9. The wood splitting system of claim 8 wherein the sliding brackets and spaced holes are disposed such that the splitter knife connection elements can be adjusted for both height and width to attach to thumbs of different sizes.

10. The wood splitting system of claim 7 wherein the edged side of the splitter knife comprises a plurality of blades disposed at about 90° to each other.

11. The wood splitting system of any claim 7 wherein the pusher connection elements comprise a rotatable arm sized and configured to be rotated to attach to differently sized powered articulating arms.

12. The wood splitting system of claim 7 wherein the pusher connection elements comprise a rotatable arm sized and configured to be rotated to attach to differently sized coupler pin widths and diameters disposed on different powered articulating arms.

13. A method of splitting wood comprising:
picking up a piece of wood between a pusher and a splitter knife that are both disposed on a powered articulating arm of a mobile machine,
squeezing the piece of wood between the pusher and the splitter knife to split the wood to create at least two pieces of split wood.

14. The method of claim 13 wherein the mobile machine is a tractor, backhoe or excavator and the squeezing is activated via controls located in a cab of the mobile machine.

15. The method of claim 13 wherein the pusher and the splitter knife are opposed to each other at a distal end of the powered articulating arm of the mobile machine.

16. The method of claim 13 wherein the splitter knife comprises a plurality of blades and the squeezing creates more than two pieces of split wood in a single squeeze.

17. The method of claim 14 wherein method further comprises lifting the split wood between the pusher and the splitter knife and then placing the split wood in a pile of split wood pieces.

18. A method comprising operating the mobile machine of any claim 1 to split wood.

19. A method of comprising
providing a wood splitting system comprising a pusher and a splitter knit, wherein the pusher comprises a wood holder area and a plurality of pusher connection elements that are sized and configured to removably attach the pusher to a first side of a distal end of a powered articulating arm of a mobile machine, the pusher connection elements having a configuration consistent with an excavator coupler, and wherein the splitter knife comprises an edged side and a plurality of splitter knife connection elements comprising at least one of sliding brackets or spaced holes, such splitter knife connection elements sized and configured to removably attach the splitter knife to a thumb located at a second side of the distal end of the powered articulating arm wherein the second side is substantially opposed to the first side of the powered articulating arm;
attaching the pusher to the first side of the distal end of the powered articulating arm of the mobile machine; and,
attaching the splitter knife to the thumb located at the second side of the distal end of the powered articulating arm.
